(19) United States
(12) Patent Application Publication
(10) Pub. No.: US 2023/0117637 A1
(43) Pub. Date: Apr. 20, 2023

(54) SAVING VOLATILE SYSTEM STATE

(71) Applicant: Arista Networks, Inc., Santa Clara, CA (US)

(72) Inventors: Fai LI, San Jose, CA (US); Elliott Benard VAN HARTINGSVELDT, San Jose, CA (US)

(21) Appl. No.: 17/504,863

(22) Filed: Oct. 19, 2021

(51) Int. Cl. G06F 12/0804; G06F 1/30

(52) U.S. Cl. CPC G06F 12/0804; G06F 1/30; G06F 2212/1032

(57) ABSTRACT

Signals (e.g., power, clock, etc.) that support operation of a processor subsystem in a computer system are supplied by support subsystems in the computer system. Fault logic in the computer system automatically reads out state information from a support subsystem in response to detection of a fault in the support system. The fault logic is separate from the processor subsystem and so can continue to function when a support subsystem fails. The state information contains fault information indicative of the state of the support subsystem at the time of failure. The fault logic stores the state information in non-volatile memory for subsequent analysis.

### BACKGROUND

The present disclosure relates to the digital circuitry that supports the operation of a processor in a digital system. Digital voltage regulators (DVRs) provide controlled voltage and current levels to the processor. Clock generating circuits provide various clock signals to synchronize the operations of the processor with other components of the digital system.

DVRs can include circuitry to detect faults, and to disable their outputs in response to detecting a fault. For example, a DVR that is designed to output power at some voltage and current level can be configured to disable that output in response to detecting an over- or under-voltage condition, an over-current condition, an over-temperature condition, and so on. Similarly, a clock generating circuit that outputs a clock signal at some clock frequency can be configured to disable the clock signal in response to detecting a deviation from that frequency.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a block diagram of an illustrative embodiment in accordance with the present disclosure.

FIG. 2 is a hardware block diagram of an illustrative embodiment in accordance with the present disclosure.

FIG. 3 is power fault detection flow in accordance with some embodiments.

FIG. 4 is a clock fault detection flow in accordance with some embodiments.

### DETAILED DESCRIPTION

Embodiments in accordance with the present disclosure are directed to saving hardware state information when a hardware failure in a system is detected. In some embodiments, for instance, processor-supporting circuits such as digital voltage regulators (DVRs), clock generators, and the like can be monitored by logic circuits other than the processor. The logic circuit can be implemented on a state machine in an FPGA.

In the case of DVRs, a digital power monitor (DPM) circuit can monitor the DVRs for proper operation. A DVR can be configured to disable its output(s) when a power fault occurs in the DVR. The fault can be detected by the DPM. For example, the DVR may output a “power-good” signal that is asserted (logic HI) when the DVR is operating properly, but de-asserted (logic LO) when the DVR experiences a fault; the HI to LO transition can be detected by the DPM. The DPM can signal the FPGA in response to detecting the transition. The FPGA, in turn, can read out state information stored in the DVR and store that state information into non-volatile memory such as flash memory, EEPROM, and the like. The state information can include information that indicates the fault, such as over-voltage, under-voltage, over-current, over-temperature, etc. The specific information that can be collected depends on the capabilities of the DVR. When the system boots up, system software (e.g., EOS) can read out the state information from the non-volatile memory for post-mortem analysis.

In the case of a clock generating subsystem that supplies clocks to the other subsystems (e.g., the processor subsystem), a clock monitoring circuit can monitor the clock generating subsystem for proper operation. The clock monitoring circuit can signal the FPGA in response to detecting a failure in the clock generating subsystem. As above, the FPGA can read out state information stored in various clock generating circuits comprising the clock generating subsystem and store that state information into the non-volatile memory. When the system boots up, the system software can read out the state information from the non-volatile memory for post-mortem analysis.

Because the FPGA can be powered by an analog voltage regulator rather than the DVRs, it’s functioning is unaffected by failures in the DVRs allowing for the FPGA to collect the state information when a failure occurs in one or more DVRs.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

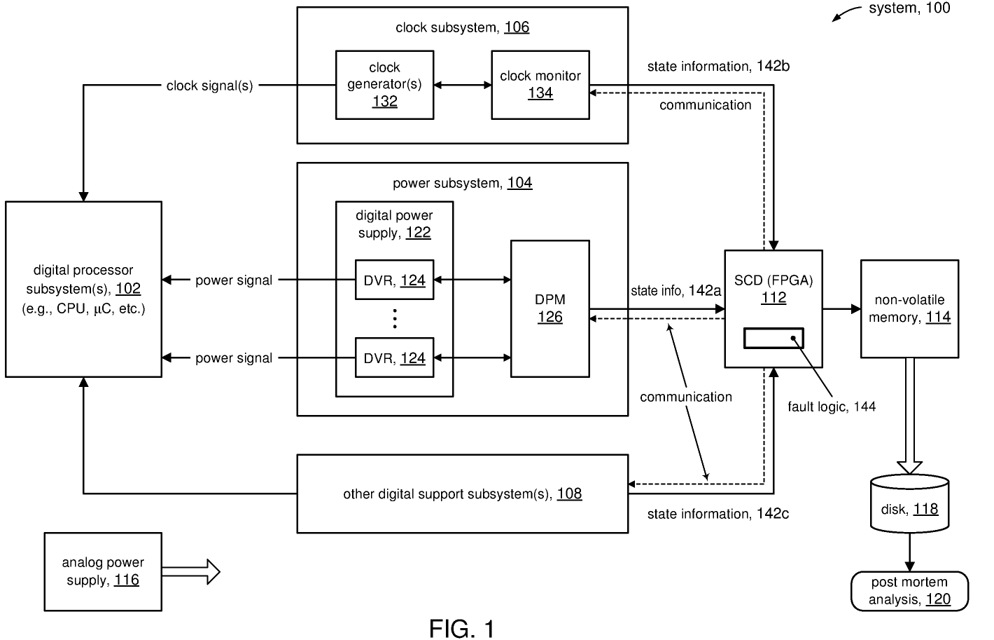

FIG. 1 is a high level functional representation of a computing system in accordance with some embodiments of the present disclosure. Computing system 100 shown in FIG. 1 can include one or more digital processor subsystems 102 such as, for example, a central processing unit (CPU), a microcontroller unit, a digital signal processor (DSP), network processing unit (NPU, e.g., switching and routing processors), graphics processing unit (GPU), and so on. Although not shown, digital processor subsystems 102 can include support hardware such as random access memory (RAM), disk storage devices, and so on. The particular digital processing components comprising digital processor subsystems 102 will vary depending on the particular device in which computing system 100 is a component.

Computing system 100 can include various support subsystems that support operations of digital processor subsystems 102. The support subsystems, for example, can provide power signals to power the digital processor subsystems, clock signals to provide a time base to synchronize operations in the digital processor subsystems, and so on. The illustrative computing system in FIG. 1, for example, includes power subsystem 104 and clock subsystem 106.

Power subsystem 104 can include digital power supply 122 comprising one or more digital voltage regulators (DVRs) 124 to supply regulated power signals to digital processor subsystems 102. Each DVR 124 can supply a specific amount of power (i.e., a given voltage level at a given current) to different components of the digital processor subsystems. Digital power supply 122 can further include a digital power monitor (DPM) 126 to control and monitor the function of the DVRs.

Clock subsystem 106 can include one or more clock generators 132 to supply clock signals to digital processor subsystems 102. Clock monitor 134 can control and monitor the function of the clock generators.

FIG. 1 shows that in some embodiments computing system 100 can include one or more digital support subsystems 108, in addition to power subsystem 104 and clock subsystem 106, that can store accessible operational state information, such as a synchronous dynamic random access memory (SDRAM) dual inline memory module (DIMM) subsystem, and so on.

In some embodiments, support subsystems 104, 106, 108 can include respective state information 142a, 142b, 142c. The state information can include operating conditions of the respective support subsystem, including conditions at the time when the respective subsystem fails. In some embodiments, for example, when a DVR in the power supply subsystem may store state information that indicates a fault condition such as over- or under-voltage, over- or under-current, over-temperature, and the like. Similarly, the clock subsystem may store state information that indicates a fault condition that results in a clock generator disabling its output, for example, in response to detecting that clock frequency falls outside a predetermined frequency range.

Computing system 100 can include a system control device (SCD) 112 that is separate from digital processor subsystem 102. SCD 112 can be configured to control subsystems 104, 106, 108. In some embodiments, SCD 112 can be implemented in logic such as a field programmable gate array (FPGA).

Analog power supply 116 can be connected to an external power source to supply power to subsystems 104, 106,108, SCD 112, and non-volatile memory 114 (e.g. flash memory, EEPROM, etc.). In some embodiments, the analog power supply can also supply power to digital processor subsystems 102 in conjunction with power from power subsystem 104.

Post mortem analysis module 120 can be configured to access the state information stored non-volatile 114. In some embodiments, the state information can be stored to a file on a disk storage system 118. Post mortem analysis module 120 can provide the state information to a user; e.g., a system administrator. In some embodiments, post mortem analysis module 120 can be software that executes on computer system 100. In other embodiments the post mortem analysis module can be on a system separate from computer system 100.

In accordance with the present disclosure, SCD 112 can include fault logic 144 to handle a failure in a subsystem 104, 106, 108. Fault logic 144 can be configured to obtain state information from subsystems 104, 106, 108 in response to occurrence of a failure. In some embodiments, for example, fault logic 144 can be configured to communicate with subsystems 104, 106, 108 to read out or otherwise obtain respective state information from the respective subsystems and store the obtained state information in non-volatile memory 114. Additional detail for this aspect of the present disclosure is discussed below. Briefly, however, fault logic 144 can perform as follows:
The fault logic detects occurrence of a fault in a support subsystem (104, 106, 108).
The fault logic reads out state information from one or more of the subsystems.
The fault logic stored the state information in non-volatile memory.
The fault logic reboots the computer system.
When the computer system reboots, the state information stored in the non-volatile memory can be read out and analyzed.
Although fault logic 144 is shown to be logic implemented in SCD 112, it will be appreciated that the fault logic is not part of the circuitry comprising the SCD.

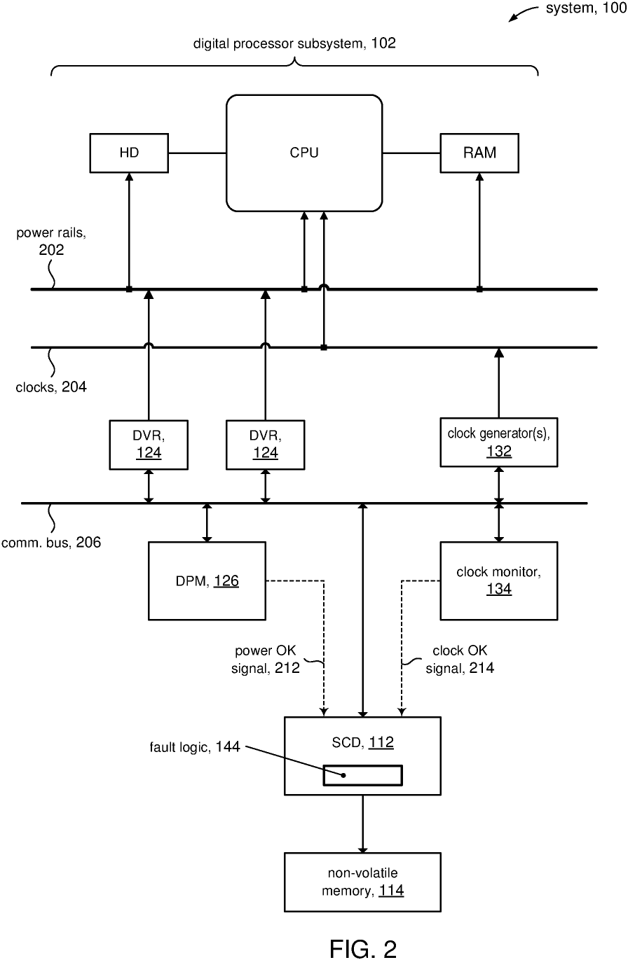

FIG. 2, illustrates a high level hardware-centric representation of computer system 100. FIG. 2 shows illustrative components comprising digital processor subsystem 102, including a CPU, a hard drive (HD), and some memory (RAM). Computer system 100 can include one or more power rails 202 to supply power to components of the digital processor subsystem. The power rails, in turn, can be supplied by DVRs 124. Computer system 100 can further include one or more clock lines 204 to supply various clock signals to the digital processor subsystem. The clock lines, in turn, can be supplied by clock generators 132.

Communication bus 206 provides device-level communication among the support circuitry, and is separate from communication buses in digital processor subsystem 102. For example, DPM 126 can communicate with DVRs 124 via communication bus 206 to control their operation, such as enabling and disabling DVR operation, setting power (voltage and current) levels, and the like. Likewise, clock monitor 134 can control operation of clock generators 132 (e.g., setting their operating frequencies). SCD 112 can be configured to communicate with the components of computer system 100 using communication bus 206.

In some embodiments, communication can include the use of known protocols. For example, the I2C protocol, the Power Management Bus (PMBus®) protocol, and the System Management Bus (SMBus) protocol are signaling protocols that specify signaling over a two-wire bus. In other embodiments, the communication protocol can be a proprietary protocol.

In accordance with the present disclosure, fault logic 144 in SCD 112 can receive power OK signal line 212 from DPM 125 and clock OK signal line 214 from clock monitor 134. Power OK signal line 212 can serve to indicate the operational state of DVMs 124; for example, a HI logic level can indicate that the DVMs are supplying the correct power to power rails 202 and operating within acceptable temperature ranges. Likewise, clock OK signal line 214 can serve to indicate the operational state of clock generators 132; e.g., the clock OK signal can be HI when the clock generators are functioning properly.

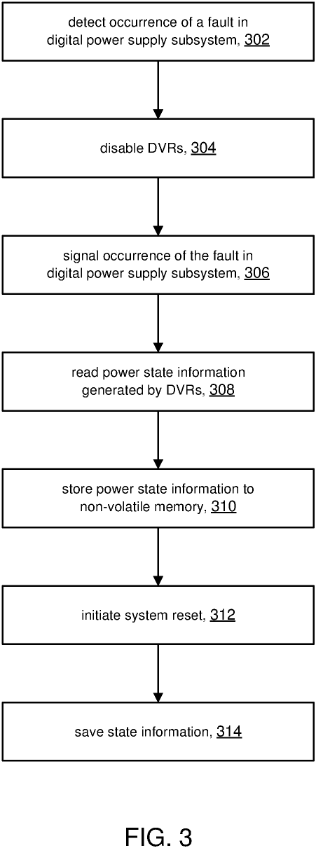

Referring to FIG. 3, the discussion will now turn to a high level description of actions in accordance with the present disclosure that take place in a computer system (e.g., 100, FIG. 1) in response to the occurrence of a fault in the power subsystem (e.g., 104). To facilitate the description, reference will be made to elements shown in the configuration of FIGS. 1 and 2 as examples.

At operation 302, the computer system can detect the occurrence of a fault condition in its power subsystem. Referring to the illustrative example of computer system 100 in FIGS. 1 and 2, for instance, a fault condition arises when a DVR outputs a voltage level outside of an acceptable range and/or a current flow outside of an acceptable range. Too high of a voltage level (over-voltage) or too high of a current flow (over-current) can damage circuitry (e.g., CPU) comprising the digital processor subsystem. Typical output voltages are less than 5 V, and the maximum voltage of the circuits they supply are typically +10% to +20% of nominal voltage, above which damage may occur. The over-voltage shutdown is set below the maximum voltage of the devices being supplied. Under-voltage shutdown cycles system power instead of allowing power-induced errors to riddle the hardware. Over-current shutdown protects the output stage of the voltage regulator and its inductor. It is set above the expected maximum operating current of the load devices, but below the maximum current of the stage and inductor. A fault condition can also arise when the operating temperature of the DVR exceeds an acceptable temperature, which can result in damage to the DVR and/or surrounding components. When a fault condition occurs in one of the DVRs, that DVR can signal the occurrence of the fault condition to DPM 126.

At operation 304, the computer system can disable all DVRs that supply power to the processor subsystem. Continuing with our example, the DVR that detects a fault condition in its circuitry can disable its output in order to protect circuits that are receiving power from the DVR, and per operation 302, the DVR can signal DPM 126. In response, the DPM can disable the other DVRs comprising power subsystem 104.

At operation 306, the computer system can signal the occurrence of a fault in its power subsystem. Continuing with our example, DPM 126 can signal a power fault in power subsystem 104 by de-asserting power OK signal line 212 (logic LO). For example, DPM 126 can assert power OK signal line 212 (logic HI) to indicate that its DVMs 124 are functioning properly; e.g., the DVMs are supplying power to power rails 202 within acceptable the acceptable voltage and current ranges, the DVRs are operating within an acceptable temperature ranges, etc. When a fault occurs in one of the DVRs, that DVR can signal the occurrence of the fault to the DPM. The DPM, in turn, can de-assert power OK signal line 212 to indicate a fault in the power subsystem.

At operation 308, the computer system can read state information stored in DVRs 124. The state information for a DVR can include information such as voltage and current levels at its output(s), device temperature of the DVR, etc. Continuing with our example, fault logic 144 can perform signaling on communication bus 206 to interact with and read out state information generated by DVRs 124. In some embodiments, for example, DPM 126 can receive state information from DVRs 124. Fault logic 144 can communicate with DPM 126 over communication bus 206 to read out or otherwise obtain the state information from the DPM by performing, for example, signaling in accordance with a known protocol such as PMBus®, SMBus, I2C, and the like. In other embodiments, fault logic 144 can communicate directly with DVRs 124 to obtain the state information from the DVRs.

We note that although the processor subsystem is disabled when the DVRs are disabled, SCD 112, which contains fault logic 144, remains enabled because the SCD is powered by analog power supply 116 rather than by the DVRs. Accordingly, fault logic 144 continues to operate and responds to the transition from HI to LO on power OK signal line 212 when the DPM de-asserts power OK signal line 212, despite the processor subsystem being disabled.

At operation 310, the computer system can store the state information to non-volatile memory. Continuing with our example, fault logic 144 can store state information received from DVRs 124 into non-volatile memory 114. Storing the state information in non-volatile memory makes the information available on the next successful boot.

At operation 312, the computer system can initiate a system reset (reboot). Continuing with our example, fault logic 144 can assert a power cycle signal to sequence main power, for example, by disabling all power to the computer system, including SCD 112, for a period of time (e.g., 5 seconds), and then restoring power. In some use cases a user (e.g., system administrator) can manually disconnect and reconnect power to the computer system to re-sequence power. When power to the computer system is restored, processor(s) (e.g., CPU) comprising the digital processor subsystem can boot up.

At operation 314, the computer system can save the state information. If the fault is no longer present subsequent to the power cycle, the CPU can boot up an operating system (OS). In accordance with the present disclosure, administrative software can be instantiated as part of the startup process after the OS boots up. In some embodiments, the administrative software can read out the state information that was stored in non-volatile memory 114 and save the information (e.g., to a file) for subsequent analysis.

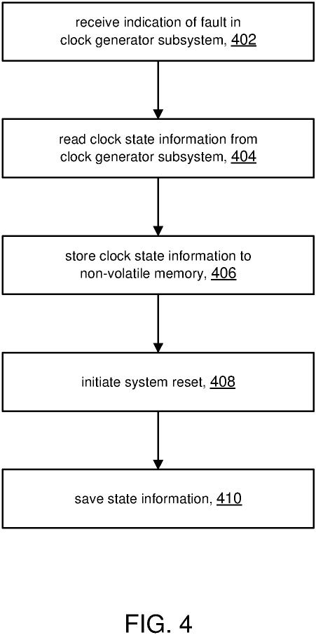

Referring to FIG. 4, the discussion will now turn to a high level description of actions in accordance with the present disclosure that take place in a computer system (e.g., 100, FIG. 1) in response to the occurrence of a fault in the clock generator subsystem (e.g., 106). To facilitate the description, reference will be made to elements shown in the configuration of FIGS. 1 and 2 as examples.

At operation 402, the computer system can signal the occurrence of a fault in its clock generator subsystem. Referring to the illustrative example of computer system 100 in FIGS. 1 and 2, for instance, clock monitor 134 can signal a fault in clock subsystem 106 by de-asserting clock OK signal line 214 (logic LO). For example, clock monitor 134 can assert clock OK signal line 214 (logic HI) to indicate that its clock generator(s) 132 are functioning properly; e.g., when the clock generators are supplying clock signals to the digital processor subsystem. When a fault occurs in one of the clock generators, the clock monitor can de-assert clock OK signal line 214 to indicate a fault in the clock subsystem. As an example, a fault is indicated when a clock generator stops outputting a clock signal.

At operation 404, the computer system can read clock state information stored in the clock subsystem. Continuing with our example, fault logic 144 can perform signaling on communication bus 206 to interact with and read out state information from clock subsystem 106. In some embodiments, for example, fault logic 144 can perform signaling in accordance with a known protocol such as PMBus®, SMBus, I2C, and the like to read out state information from clock monitor 134. In other embodiments, fault logic 144 can access the clock generators directly to read out the state information.

Although the processor subsystem may be disabled when one of the clock generators is disabled, SCD 112, which contains fault logic 144, can remain enabled, for example, because the SCD is clocked by a separate clock circuit (e.g., a clock crystal, not shown) in the SCD. Accordingly, fault logic 144 can respond to the transition from HI to LO on clock OK signal line 214 when clock monitor 134 de-asserts clock OK signal line 214, despite the processor subsystem being disabled.

At operation 406, the computer system can store the state information to non-volatile memory. Continuing with our example, fault logic 144 can store state information received from clock monitor 134 into non-volatile memory 114.

At operation 408, the computer system can initiate a system reset (reboot). Continuing with our example, fault logic 144 can assert a power cycle signal that serves to disable all power to the computer system, including SCD 112, for a period of time (e.g., 5 seconds). When power to the computer system is restored, processor(s) (e.g., CPU) comprising the digital processor subsystem can boot up.

At operation 410, the computer system can save the state information. If the fault is no longer present subsequent to the reboot, the CPU can boot up an operating system (OS). In accordance with the present disclosure, administrative software can be instantiated. In some embodiments, for example, the computer system can read out the state information stored in non-volatile memory 114 and save the information to a file.

In some embodiments a failure in one support subsystem (e.g., power subsystem 104) can trigger fault logic 144 to read out state information from other support subsystems in addition to the subsystem that experiences the fault. For example, if the power subsystem signals a fault, the fault logic can be configured to read out state information from the clock subsystem in addition to the power subsystem, and vice versa. This can provide a more complete view of the computer system at the time of failure.

### Further Examples

In accordance with the present disclosure, a computer system includes one or more data processing units; one or more digital power supplies to provide power to the one or more data processing units; a power monitoring circuit in communication with the one or more digital power supplies; a fault handling circuit, separate from the one or more data processing units; and a non-volatile memory in data communication with the fault handling circuit. The fault handling circuit is configured to: access state information generated by the digital power supplies in response to the power monitoring circuit indicating occurrence of a fault in at least one of the one or more digital power supplies; and store the accessed state information in the non-volatile memory.

In some embodiments, the computer system further includes an analog power supply, separate from the one or more digital power supplies, connected to provide power to the fault handling logic.

In some embodiments, the fault handling circuit is further configured to initiate a reboot of the computer system.

In some embodiments, the fault handling circuit is further configured to communicate with the power monitoring circuit to access the state information.

In some embodiments, the fault handling circuit is further configured to access the state information using PMBus protocol, SMbus protocol, or I2C protocol.

In accordance with the present disclosure, a computer system includes one or more data processing units; a clock generator subsystem comprising one or more clock chips to provide one or more clock signals to the one or more data processing units; a clock monitoring circuit in communication with the clock generator subsystem; a fault handling circuit, separate from the one or more data processing units; and a non-volatile memory in data communication with the fault handling circuit. The fault handling circuit is configured to: access state information stored in the one or more clock chips of the clock generator subsystem in response to the clock monitoring circuit indicating occurrence of a fault in the clock generator subsystem; and store the accessed state information in the non-volatile memory.

In some embodiments, the computer system further includes an analog power supply, separate from the plurality of digital power supplies, connected to provide power to the fault handling logic.

In some embodiments, the fault handling circuit is further configured to initiate a reboot of the computer system.

In some embodiments, the fault handling circuit is further configured to communicate with the power monitoring circuit to access the state information.

In some embodiments, the fault handling circuit is further configured to access the state information using PMBus protocol, SMbus protocol, or I2C protocol.

In accordance with the present disclosure, a method in a computer system includes detecting occurrence of a fault in a subsystem of the computer system that supplies electrical signals to one or more data processors of the computer system; reading state information on a communication bus in the computer system in response to detecting the fault, the state information being generated by one or more chips comprising the subsystem; and storing the state information to a non-volatile memory.

In some embodiments, the method further includes initiating a reboot sequence to reboot the computer system. In some embodiments, the method further includes, subsequent rebooting the computer system, reading out the state information stored in the non-volatile memory and storing the state information in a file on a disk storage system.

In some embodiments, the method further includes performing the method by logic circuitry separate from any of the one or more data processors of the computer system.

In some embodiments, the communication bus is separate from any communication bus used by the one or more data processors.

In some embodiments, reading the state information includes communicating with the subsystem using PMBus protocol, SMbus protocol, or I2C protocol.

In some embodiments, the electrical signals includes one or more of electrical power signals and clock signals.

In some embodiments, the subsystem is a power subsystem that supplies electrical power to the one or more data processors, the power subsystem comprising one or more power chips, wherein the state information represents electrical and temperature states of the one or more power chips.

In some embodiments, the power subsystem further comprises a power monitor circuit, wherein reading the state information includes communicating with the power monitor circuit to read the state information from the power monitor circuit.

In some embodiments, the subsystem is a clock subsystem that supplies one or more clock signals to the one or more data processors, the clock subsystem comprising one or more clock chips, wherein the state information represents respective frequencies of one or more clock signals generated by the one or more clock chips.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A computer system comprising:
one or more data processing units;
one or more digital power supplies to provide power to the one or more data processing units;
a power monitoring circuit in communication with the one or more digital power supplies;
a fault handling circuit, separate from the one or more data processing units; and
a non-volatile memory in data communication with the fault handling circuit,
the fault handling circuit configured to:
access state information generated by the digital power supplies in response to the power monitoring circuit indicating occurrence of a fault in at least one of the one or more digital power supplies; and
store the accessed state information in the non-volatile memory.

2. The computer system of claim 1, further comprising an analog power supply, separate from the one or more digital power supplies, connected to provide power to the fault handling logic.

3. The computer system of claim 1, wherein the fault handling circuit is further configured to initiate a reboot of the computer system.

4. The computer system of claim 1, wherein the fault handling circuit is further configured to communicate with the power monitoring circuit to access the state information.

5. The computer system of claim 1, wherein the fault handling circuit is further configured to access the state information using PMBus protocol, SMbus protocol, or I2C protocol.

6. A computer system comprising:
one or more data processing units;
a clock generator subsystem comprising one or more clock chips to provide one or more clock signals to the one or more data processing units;
a clock monitoring circuit in communication with the clock generator subsystem;
a fault handling circuit, separate from the one or more data processing units; and
a non-volatile memory in data communication with the fault handling circuit,
the fault handling circuit configured to:
access state information stored in the one or more clock chips of the clock generator subsystem in response to the clock monitoring circuit indicating occurrence of a fault in the clock generator subsystem; and
store the accessed state information in the non-volatile memory.

7. The computer system of claim 6, further comprising an analog power supply, separate from the plurality of digital power supplies, connected to provide power to the fault handling logic.

8. The computer system of claim 6, wherein the fault handling circuit is further configured to initiate a reboot of the computer system.

9. The computer system of claim 6, wherein the fault handling circuit is further configured to communicate with the power monitoring circuit to access the state information.

10. The computer system of claim 6, wherein the fault handling circuit is further configured to access the state information using PMBus protocol, SMbus protocol, or I2C protocol.

11. A method in a computer system comprising:
detecting occurrence of a fault in a subsystem of the computer system that supplies electrical signals to one or more data processors of the computer system;
reading state information on a communication bus in the computer system in response to detecting the fault, the state information being generated by one or more chips comprising the subsystem; and
storing the state information to a non-volatile memory.

12. The method of claim 11, further comprising initiating a reboot sequence to reboot the computer system.

13. The method of claim 12, further comprising, subsequent rebooting the computer system, reading out the state information stored in the non-volatile memory and storing the state information in a file on a disk storage system.

14. The method of claim 11, further comprising performing the method by logic circuitry separate from any of the one or more data processors of the computer system.

15. The method of claim 11, wherein the communication bus is separate from any communication bus used by the one or more data processors.

16. The method of claim 11, wherein reading the state information includes communicating with the subsystem using PMBus protocol, SMbus protocol, or I2C protocol.

17. The method of claim 11, wherein the electrical signals includes one or more of electrical power signals and clock signals.

18. The method of claim 11, wherein the subsystem is a power subsystem that supplies electrical power to the one or more data processors, the power subsystem comprising one or more power chips, wherein the state information represents electrical and temperature states of the one or more power chips.

19. The method of claim 18, wherein the power subsystem further comprises a power monitor circuit, wherein reading the state information includes communicating with the power monitor circuit to read the state information from the power monitor circuit.

20. The method of claim 11, wherein the subsystem is a clock subsystem that supplies one or more clock signals to the one or more data processors, the clock subsystem comprising one or more clock chips, wherein the state information represents respective frequencies of one or more clock signals generated by the one or more clock chips.
